(19) United States
(12) Patent Application Publication
(10) Pub. No.: US 2023/0388844 A1
(43) Pub. Date: Nov. 30, 2023

(54) TRANSLATING COMMANDS FOR LEGACY RADIO ACCESS NETWORK

(71) Applicant: VMware, Inc., Palo Alto, CA (US)

(72) Inventors: Christopher Jon Dent, Newquay (GB); Alexandros George Anemogiannis, Redwood City, CA (US); Raghavendra Murali, Sunnyvale, CA (US)

(21) Appl. No.: 17/827,032

(22) Filed: May 27, 2022

(51) Int. Cl. H04W 28/02; H04W 72/04

(52) U.S. Cl. CPC H04W 28/0215; H04W 72/048; H04W 28/0268

(57) ABSTRACT

Some embodiments provide a method for modifying settings of a legacy RAN at a first application executing on a RAN intelligent controller (MC) framework. From a second application executing on the MC framework, the method receives a command to modify at least one setting of the legacy RAN. The method translates the command into a set of one or more API calls to an element management system (EMS) for the legacy RAN. the method sends the API calls to the EMS in order to cause the EMS to modify the at least one setting of the legacy RAN.

### BACKGROUND

In telecommunications networks, the Radio Access Network (RAN) performs more and more functions with each iteration of the telecommunications standards. That is, in order to enable the advantages of 5G over previous standards, the 5G RAN performs various additional functions. Some of these functions are performed by applications that may operate in the cloud or at the base stations (e.g., cell towers). The switch from 4G to 5G for a given network will typically progress over a period of time, however, with user devices able to connect to either 4G or 5G networks. Thus, it would be useful for the 5G RAN applications to be able to exert control over the 4G networks.

### BRIEF SUMMARY

Some embodiments provide a method for modifying settings of a legacy radio access network (RAN) by an application executing on a 5G RAN intelligent controller (MC) framework (e.g., a non-real-time (non-RT) RIC). Applications that execute on the non-RT MC may modify settings of 5G network elements (e.g., powering cell sites on or off) via either a near-RT MC or directly via Distributed Unit (O-DU) and/or Centralized Unit (O-CU) elements of the 5G RAN. To enable these applications to modify similar settings for a legacy RAN (e.g., 4G LTE cell sites), a translation application also executes on the MC framework. The translation application receives a command from another application to modify at least one setting of the legacy RAN, translates the command into one or more application programming interface (API) calls to an element management system (EMS) for the legacy RAN, and sends the API calls to the EMS, thereby causing the EMS to modify the specified RAN settings.

In some embodiments, the application sending the command communicates with the translation application via an inter-application communication interface (e.g., the R1 interface) of the non-RT RIC. Specifically, in some embodiments, the application creates a job on a data management and exposure (DME) service of the R1 interface. The DME service identifies the translation application as the destination for the created job and sends this job to the translation application. Once the translation application has communicated with the EMS and received confirmation of the completion of the command (as further described below), the translation application directly notifies the other application through the R1 interface (though not necessarily through the DME).

The various applications executing on the non-RT RIC framework (also referred to as rApps) can communicate with the EMS for the legacy RAN (via the translation application) to read settings data and/or modify settings in some embodiments via a set of generic data types that the translation application exposes to the other rApps. In some embodiments, the rApps can learn the current settings of the legacy RAN via read commands that specify a legacy RAN cell site and request the current value of a specific parameter for that legacy cell site. The rApps can also modify the value(s) of a single parameter for a specific cell site via write commands that do not use the DME service (i.e., are instead sent directly to the translation application) in some embodiments.

Finally, some embodiments provide for asynchronous write commands that allow the rApps to specify at least one new value for at least one parameter of at least one legacy RAN cell site. More specifically, each such command includes a set of tuples, with each respective tuple specifying (i) a legacy RAN cell site, (ii) a parameter to be modified for the legacy RAN cell site, and (iii) a set of one or more new values for the parameter. In some embodiments, the translation application generates a work order (with a set of API calls to effectuate the command) to send to the EMS based on these specified new values. This work order, in some embodiments, also indicates whether the changes should only be committed to the RAN by the EMS if all of the indicated changes can be made or whether partial success is allowed. Once the EMS has made these changes (or failed to do so), the EMS reports back to the translation application, which can in turn notify the rApp that originated the command.

Multiple different applications (i.e., multiple rApps) that perform different functions can read and modify settings of the legacy RAN from the EMS via the translation application in some embodiments. Rather than needing to modify every rApp that may need to change settings in the legacy RAN to communicate with the EMS, the translation application provides a single application (itself also an rApp in some embodiments) that can translate any of these commands into the appropriate API calls for the EMS.

In addition, the translation application of some embodiments can provide translations for multiple different EMSs (e.g., managing the same or different legacy RANs). In some embodiments, the translation application includes multiple different translation modules, each of which translates commands into the appropriate API calls for a different EMS. When the translation application of some such embodiments receives a command, the translation application maps the command to a specific translation module based on, e.g., the legacy RAN cell site(s) specified in the command. In some embodiments, each legacy RAN cell site is assigned a unique identifier that is used for communication between the rApps and the translation application.

The rApps may need to modify legacy RAN settings for a variety of different purposes. One such example is in order to specify 5G new radio (NR) cell site anchors for a 4G LTE cell site. In some embodiments, a user device connects to the RAN by initially connecting to an LTE cell. This cell is configured with a set of one or more NR “anchor” cell sites so that the user device connection can be transferred to one of these NR anchor cell sites (e.g., for certain types of traffic). In some embodiments, an rApp will change the set of NR anchor cell sites for one or more LTE cell sites (based on analysis of network topology, available bandwidth, etc.) by issuing a command to the translation application. The translation application then communicates the new set of NR anchor cell sites to the EMS for that LTE cell site.

In another example, an rApp can evaluate (e.g., using machine learning based on recent historical data) when certain cell sites (both NR and LTE cell sites) should be powered off to save energy (e.g., because traffic in the area is expected to be low). For NR cell sites, the rApp can provide this data directly to other 0-RAN components. However, for the LTE cell sites, different EMSs may use different API commands in order to modify this cell site configuration setting (e.g., changing an administrative state between locked and unlocked). The translation application is configured to translate a command to power off a specific cell site into the appropriate API command for the EMS managing that cell site.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and the Drawings is needed. Moreover, the claimed subject matters are not to be limited by the illustrative details in the Summary, Detailed Description, and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 illustrates an example of O-RAN architecture according to some embodiments.

FIG. 2 conceptually illustrates the non-RT RIC of some embodiments in further detail.

FIG. 3 conceptually illustrates a process for translating commands to modify RAN settings into API calls for management systems (EMSs) that manage legacy RAN elements.

FIG. 4 conceptually illustrates the architecture of a translation application in more detail.

FIG. 5 conceptually illustrates the structure of a write command of some embodiments.

FIG. 6 conceptually illustrates a read command and a response to that read command.

FIG. 7 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method for modifying settings of a legacy radio access network (RAN) by an application executing on a 5G RAN intelligent controller (MC) framework (e.g., a non-real-time (non-RT) RIC). Applications that execute on the non-RT MC may modify settings of 5G network elements (e.g., powering cell sites on or off) via either a near-RT MC or directly via Distributed Unit (O-DU) and/or Centralized Unit (O-CU) elements of the 5G Open RAN (O-RAN). To enable these applications to modify similar settings for a legacy RAN (e.g., 4G LTE cell sites), a translation application also executes on the MC framework. The translation application receives a command from another application to modify at least one setting of the legacy RAN, translates the command into one or more application programming interface (API) calls to an element management system (EMS) for the legacy RAN, and sends the API calls to the EMS, thereby causing the EMS to modify the specified RAN settings.

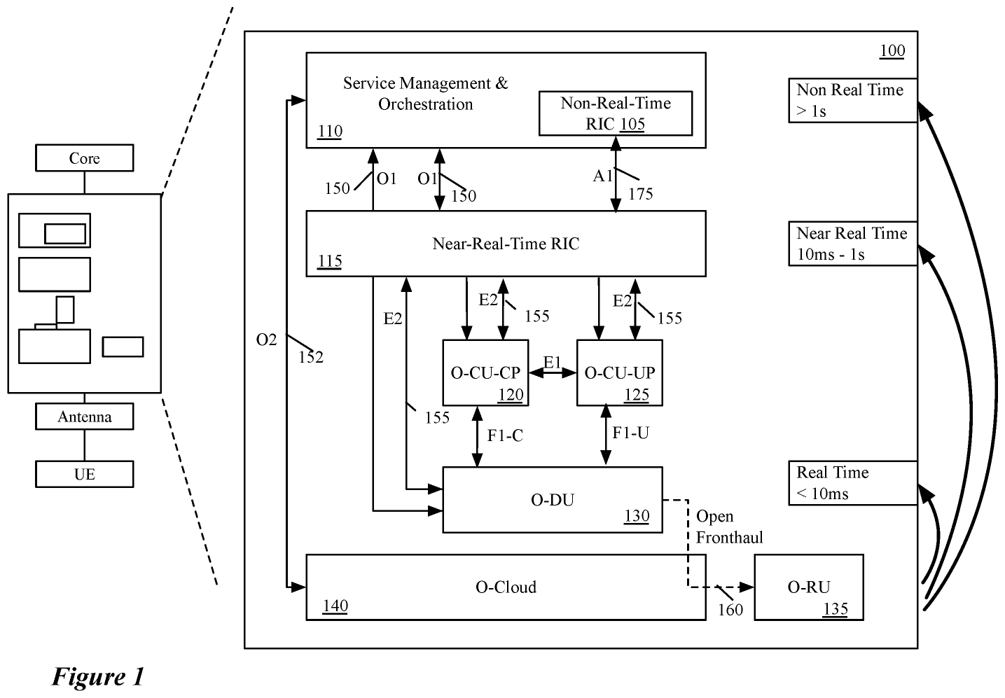

O-RAN is a standard for allowing interoperability for RAN elements and interfaces. FIG. 1 illustrates an example O-RAN architecture of some embodiments. The O-RAN architecture 100 includes a service management and orchestration framework (SMO) 110 with a non-real-time MC 105, a near real-time MC 115, an open central unit control plane (O-CU-CP) 120, an open central unit user plane (O-CU-UP) 125, an open distributed unit (O-DU) 130, an open radio unit (O-RU) 135, and an O-Cloud 140. The O-CU-CP 120, the O-CU-UP 125, and the O-DU 130 may be collectively referred to as managed functions.

As defined in the standard, the SMO 110 in some embodiments includes an integration fabric that allows the SMO to connect to and manage the near-real-time MC 115, the managed functions 120-130, and the O-Cloud 140 via the open interfaces 150 and 152. Unlike these elements, the O-RU 135 is not managed by the SMO 110 and is instead managed by the O-DU 130 in some embodiments, as indicated by the dashed line 160. In some embodiments, the O-RU 135 processes and sends radio frequencies to the O-DU 130.

In some embodiments, the managed functions 120-130 are logical nodes that each host a set of protocols. According to the O-RAN standard, for example, the O-CU-CP 120, in some embodiments, include protocols such as radio resource control (RRC) and the control plane portion of packet data convergence protocol (PDCP), while the O-CU-UP 125 includes protocols such as service data adaptation protocol (SDAP), and the user plane portion of PDCP.

The two RICs are each adapted to specific control loop and latency requirements. The near-real-time (near-RT) RIC 115 provides programmatic control of O-CUs and O-DUs on time cycles of 10 ms to 1 second. The non-real-time RIC (non-RT RIC) 105, on the other hand, provides higher layer policies (e.g., modifying RAN configuration settings) that can be implemented in the RAN either via the near-RT RIC 115 or via a direct connection to RAN nodes. The non-RT RIC is used for control loops of more than 1 second. Each RIC 105 or 115 serves as a platform on which RAN control applications execute. These applications can be developed by third-party suppliers that are different from the RIC vendors. These applications are referred to as “xApps” (for the near-RT RIC 115) and “rApps” (for the non-RT RIC 105).

The near real-time RIC 115, in some embodiments, is a logical aggregation of several functions that use data collection and communications over the interfaces 155 in order to control the managed functions 120-130. In some embodiments, the non-RT RIC 105 uses machine learning and model training in order to manage and optimize the managed functions 120-130. The near-RT RIC 115 in some embodiments also uses machine learning. The near-RT RIC 115 and non-RT RIC 105 communicate via the A1 interface 175.

In some embodiments, the O-Cloud 140 is responsible for creating and hosting virtual network functions (VNFs) for use by the near-RT RIC 115 and the managed functions 120-130. In some embodiments, the DU is in charge of per-slot decisions of user scheduling and includes a RAN scheduler that performs MAC control assistance and user-level tracing. In order to increase computing power available in the cloud (i.e., compared to base stations that typically execute the RAN functions), the near-RT RIC and/or non-RT RIC may be implemented in one or more public and/or private cloud datacenters.

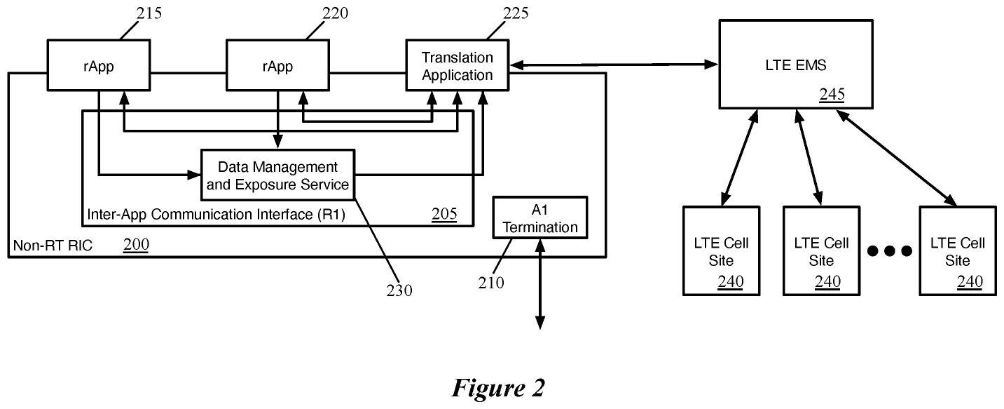

FIG. 2 conceptually illustrates the non-RT MC 200 of some embodiments in further detail. As shown, the non-RT RIC 200 includes an inter-application communication interface (referred to as the R1 interface) 205 as well as a termination 210 for the A1 interface (for communication with the near-RT MC). As shown, multiple applications (rApps) 215-225, including the translation application 225, execute on the non-RT RIC framework 200.

While the figure illustrates two rApps 215 and 220 in addition to the translation application 225, it should be understood that in different embodiments any number of rApps may execute on the non-RT RIC framework 200. Some or all of these rApps may communicate with the translation application 225, depending on whether the rApps require data from legacy RAN(s) and/or modify configuration settings of the legacy RAN(s). Some rApps do not directly modify RAN settings but instead provide data to other rApps or to the near-RT RIC (e.g., to the xApps executing on the near-RT RIC framework).

The inter-application communication interface 205 (referred to in the standard as the R1 interface) enables communication between the translation application 225 and the other rApps 215 and 220 (as well as between any other rApps). The R1 interface 205 includes a data management and exposure (DME) service 230 that (i) mediates discovery of data types for the rApps and (ii) enables delivery of jobs between consuming rApps and producing rApps. In some embodiments, the translation application 225 shares multiple data types via the DME service 230 that the other rApps 215 and 220 use to send commands to the translation application 225. As described further below, these data types allow the rApps 215 and 220 to read configuration setting data from the legacy RAN and modify these configuration settings.

In some embodiments, when one of the rApps 215 and 220 sends a command to read configuration setting data from the legacy RAN, this command is sent directly to the translation application 225 through the R1 interface (i.e., without the involvement of the DME service 230). On the other hand, for most commands to modify the translation settings, the consuming rApp 215 or 220 uses one of the data types to create a job request on the DME service 230 specifying the changes to be made. The DME service 230 then identifies the translation application 225 as the producing rApp for the job and sends the job to the translation application 225. Once the translation application 225 has performed its translation and received confirmation of the completion of the command (as further described below), the translation application 225 directly notifies the consuming rApp through the R1 interface (i.e., without involving the DME service 230).

The rApps 215 and 220 may need to read and/or modify configuration settings of both 5G RAN settings and legacy RAN settings. For the 5G network, the rApps 215 and 220 either use the A1 interface to communicate with the near-RT MC or use the SMO layer to communicate directly with the O-Cloud and/or managed functions of the O-RAN. However, for the legacy RAN (e.g., LTE RAN), these network elements (e.g., LTE cell sites 240) are not managed through the O-RAN but rather by an EMS 245 that has its own set of APIs. Thus, the rApps 215 and 220 send their commands to the translation application 225 as described above. The translation application 225 translates these commands into a set of API calls to the legacy EMS 245 for the LTE network. The LTE EMS 245 communicates with the specific LTE cell sites 240 when configuration settings need to be modified in order to execute these changes specified by the rApps 215 and 220.

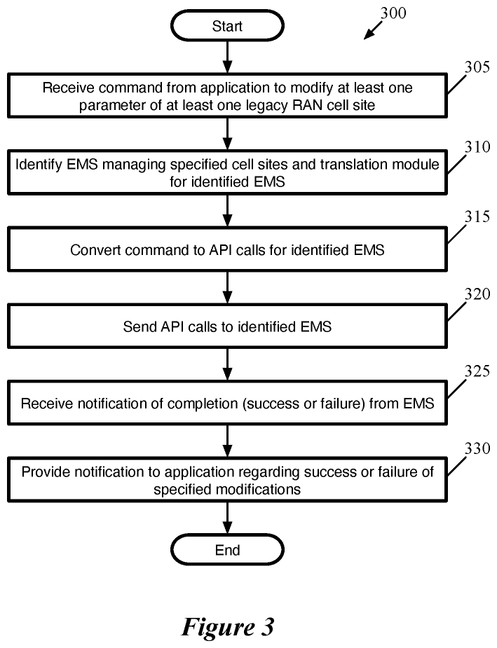

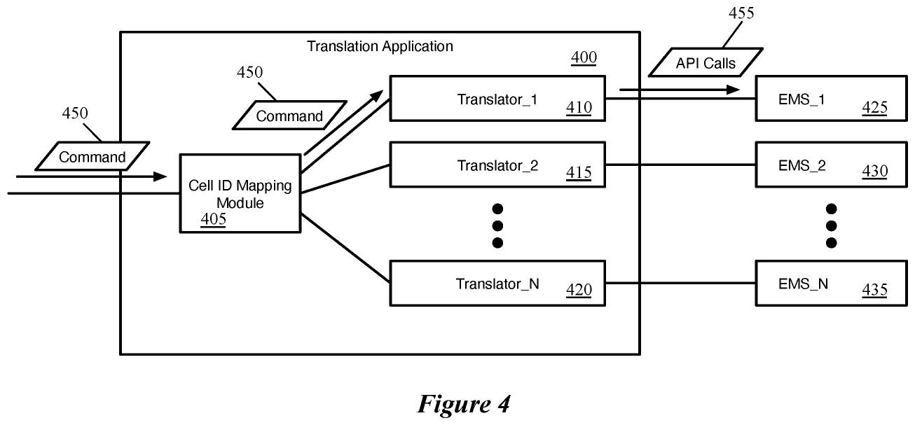

FIG. 3 conceptually illustrates a process 300 for translating commands to modify RAN settings into API calls for management systems (EMSs) that manage legacy RAN elements. The process 300 is performed by a translation application (e.g., application 225) that operates on the same non-RT RIC framework as the application that initiates the command in some embodiments. The process 300 will be described in part by reference to FIG. 4, which conceptually illustrates the architecture of a translation application 400 in more detail.

The translation application 400 includes a cell ID mapping module 405 as well as a set of translator modules 410-420. Each of the translator modules 410-420 translates commands for a different EMS 425-435, as each of the EMSs will have a different set of APIs such that the same command may be translated into completely different API calls for two different EMSs. In many cases, a given translation application 400 may only include a single translator module, if the translation application operates in a non-RT RIC that manages only a single legacy RAN with a single EMS. For instance, a given mobile service provider may have a single mixed 4G/5G network (i.e., during transition to 5G) with all of the legacy (4G LTE) network elements managed by the same EMS. On the other hand, due to mergers, acquisitions, and/or other reasons, a non-RT RIC of a mobile service provider might manage multiple legacy RANs (with separate EMSs) in some embodiments, necessitating a translation application that can translate commands for any of these EMS.

When there is more than one EMS 425-435, and therefore more than one translator module 410-420, the cell ID mapping module 405 identifies which of the translator modules 410-420 will be used to translate a command received by the translation application 400. In some embodiments, commands from the other rApps include one or more globally unique cell identifiers that specify cell sites for which the configuration settings are to be modified (or simply requested, for a read command). The cell ID mapping module 405 stores a table or other data structure that maps each of these cell IDs to the EMS 425-435 that manages the corresponding cell site (and thus to the appropriate translator module 410-420). Thus, the translation application enables the other rApps to be transparent to the number of different EMSs, or even the existence of the EMS at all.

Turning to FIG. 3, the process 300 begins by receiving (at 305) a command from an application to modify at least one parameter of at least one legacy cell site. In some embodiments, as mentioned, this command is received through the DME of the R1 interface as a job request. The rApps may need to modify legacy RAN settings for a variety of different purposes. One such example is in order to specify 5G new radio (NR) cell site anchors for a 4G LTE cell site. In some embodiments, a user device connects to the 4G/5G network by initially connecting to an LTE cell. This cell is configured with a set of one or more NR “anchor” cell sites so that the user device connection can be transferred to one of these NR anchor cell sites (e.g., for certain types of traffic). In some embodiments, an rApp will change the set of NR anchor cell sites for one or more LTE cell sites (based on analysis of network topology, available bandwidth, etc.) by issuing a command to the translation application. The translation application then communicates the new set of NR anchor cell sites to the EMS for that LTE cell site. It should be noted that, while the process 300 describes the translation and execution of a command to modify legacy cell site parameters, similar operations are also performed by the translation application to enable an application to retrieve legacy cell site parameters.

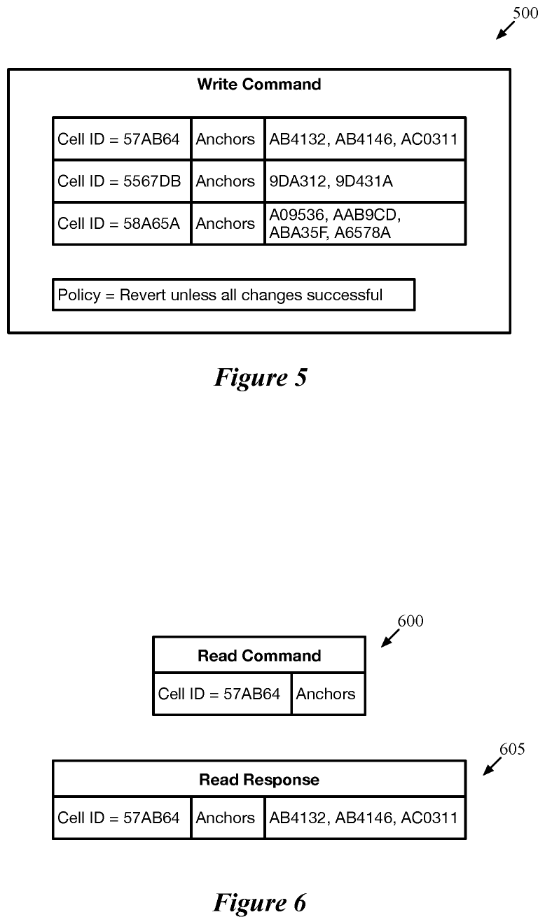

FIG. 5 conceptually illustrates the structure of such a write command 500 of some embodiments. In this example, the command 500 specifies the 5G (New Radio, or NR) cell sites that can act as anchors for each of a set of 4G LTE cell sites. As shown, the command specifies a set of data tuples (in this case three data tuples), each of which includes a single LTE cell ID (i.e., the cell site for which the configuration is to be modified), a parameter identifier (i.e., the configuration parameter that is to be modified), and a set of one or more new (modified) values for the parameter. For instance, the first data tuple in the command 500 specifies that for the LTE cell site with cell ID 57AB64, the anchor NR cell sites will be set to sites AB4132, AB4146, and AC0311. In some embodiments, each of the value fields can be a Boolean value, an integer value, a string value, a list of such values, a JSON object that maps strings to arbitrary values, or another type of value. In this example, each of the values is a list of hexadecimal values (identifying NR cell sites), though in other embodiments the NR cell sites could be identified by decimal integers, strings, etc.

In some embodiments, each of the data tuples in the write command 500 also indicates an operation such as set, add, or remove. This allows for more complex operations than simply setting a new set of one or more values to the specified parameter for the specified cell site. For instance, a data tuple could remove a single anchor from the list of anchors for an LTE cell site or add new anchors to the existing list of anchors for the LTE cell site (without a need to list all of the existing anchors in the command). If no operation is specified, the translation application of some embodiments automatically treats the tuple as a set operation.

The write command 500 also specifies a policy that indicates how partial failure should be handled. In different situations, the initiating rApp can specify for all of the attempted modifications to revert if the EMS is unable to effect one or more of the changes or to allow for partial failure (and thereby commit any changes that can be made).

The write command 500 indicates one example of the type of change that an rApp may specify for a legacy cell site (or for an NR cell site). In another example, an rApp can evaluate when certain cell sites (both NR and LTE cell sites) should be powered off to save energy. For instance, in some embodiments an rApp uses machine learning to analyze historical cell site usage data (e.g., data from the last 24 hours, 7 days, 30 days, etc.) to determine when a particular cell site will not be needed for a long enough period that it is useful to power off the cite. For NR cell sites, the rApp provides this data directly to other 0-RAN components (e.g., to the near-RT RIC via the A1 interface). However, for the LTE cell sites, the rApp provides write commands to the translation application indicating a new status for each of one or more LTE cell sites.

Returning to the FIG. 3, the process 300 identifies (at 310) the EMS managing the specified cell sites and the translation module for that identified EMS. As indicated above, in some embodiments a mapping module of the translation application maps the globally unique cell site identifier of each data tuple in the received command to one of the translation modules. In some cases, a single write command could include data tuples that map to multiple different legacy RANs, and thus to different translation modules. Referring to FIG. 4, a command 450 is received at the cell ID mapping module 405. In this case, the cell ID mapping module 405 provides the command to the first translator module 410 based on mapping the cell ID(s) in the command 450 to the corresponding first EMS 425.

Next, the process 300 converts (at 315) the command to a set of one or more API calls for the identified EMS. In some embodiments, the translator module receives the command as one or more function calls. Specifically, some embodiments receive write commands such as that shown above as a multiset( ) function call indicating to set one or more values according to the policy and/or operations specified in the write command (i.e., in the job request provided to the translation application by the R1 DME service). The translation module translates the network element (cell site) identifiers, configuration parameter identifiers, and the values into the correct scheme used by the EMS. In addition, the translation module translates the parameter change semantics (i.e., set parameter X of cell site Y to value Z) into the scheme used by the EMS, which requires additional context in some embodiments.

Different EMSs for different legacy RANs may have vastly different APIs, such that the same actions require completely different function calls as well as different parameter names and values. For instance, to power cell sites on or off, one EMS might require a call to change the administrative state to locked (from unlocked) while another EMS instead requires a call to change a power setting to off. The different translation modules are configured to translate the write commands (or read commands, as described below) into the appropriate calls for their corresponding EMS so that a single rApp can communicate with any legacy EMS using the same set of commands (avoiding the need to develop a new version of the rApp for every non-RT RIC deployment).

The process then sends (at 320) the API calls to the appropriate EMS. In some embodiments, the API calls are formatted as a work order or plan that is sent to the EMS, in order to also embed the partial failure policy for the modifications. Referring again to FIG. 4, the first translator module 410 (identified for translating the command 450) sends a set of API calls 455 to its corresponding EMS 425. While this figure shows direct communication between the translator modules 410-420 and their respective EMSs 425-435, other embodiments include a communication module that is responsible for communicating with the various EMS interfaces.

After a period of time, the process 300 receives (at 325) a notification of completion from the EMS. In some embodiments, this notification (received through the EMS API) indicates whether the modifications were successfully committed to the RAN configuration or whether some or all of the modifications could not be made.

Finally, the process 300 provides (at 330) a corresponding notification regarding the success or failure of the specified operations to the originating application (i.e., the rApp). Whereas the command is received as a job request via the R1 DME service, in some embodiments the translation application notifies the other rApp directly through the R1 interface (i.e., without the involvement of the DME service). The rApp can then account for these changes to the RAN configuration having been made (or not, depending on their success). The process 300 then ends.

As mentioned, in addition to the write command shown in FIG. 5, the translation application of some embodiments allows other commands (by exposing other data types). In some embodiments, the rApps can learn the current settings of the legacy RAN via read commands that specify a legacy RAN cell site and request the current value of a specific parameter for that legacy cell site. FIG. 6 conceptually illustrates such a read command 600 and a response 605 to that read command. As shown, the read command of some embodiments allows an rApp to request the value of a specific parameter for a specific cell ID. In this example, the read command 605 requests the NR anchor sites for LTE cell 57AB64. The read command is sent directly to the translation application via the R1 interface in some embodiments (i.e., without involvement of the DME service) The translation module for the correct EMS receives this as a get( ) function call and translates the call into the appropriate API call for its EMS. In some embodiments, the response 605 provided to the rApp upon receiving a response from the EMS is a tuple with the unique LTE cell ID, parameter, and returned values. Other embodiments, because this is a synchronous operation, simply provide the returned values.

The write command described above is an asynchronous write command that allows an rApp to specify values for multiple parameters of multiple legacy RAN cell sites. Some embodiments also enable synchronous write commands to set the value for one parameter for one LTE cell ID using, e.g., a format similar to the read response 605. This synchronous write command, in some embodiments, is primarily used for testing purposes.

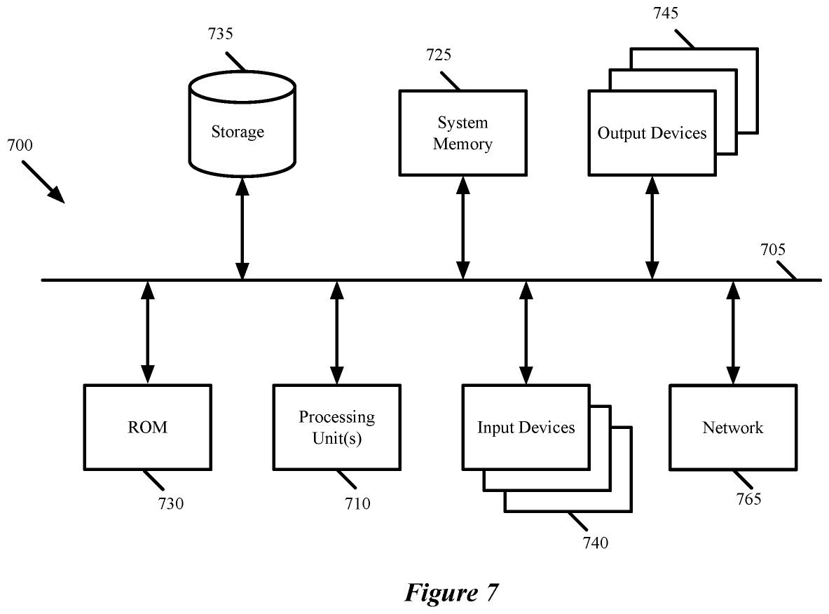

FIG. 7 conceptually illustrates an electronic system 700 with which some embodiments of the invention are implemented. The electronic system 700 may be a computer (e.g., a desktop computer, personal computer, tablet computer, server computer, mainframe, a blade computer etc.), or any other sort of electronic device. Such an electronic system 700 includes various types of computer-readable media and interfaces for various other types of computer-readable media. Electronic system 700 includes a bus 705, processing unit(s) 710, a system memory 725, a read-only memory 730, a permanent storage device 735, input devices 740, and output devices 745.

The bus 705 collectively represents all system, peripheral, and chipset buses that communicatively connect the numerous internal devices of the electronic system 700. For instance, the bus 705 communicatively connects the processing unit(s) 710 with the read-only memory 730, the system memory 725, and the permanent storage device 735.

From these various memory units, the processing unit(s) 710 retrieve instructions to execute and data to process in order to execute the processes of the invention. The processing unit(s) 710 may be a single processor or a multi-core processor in different embodiments.

The read-only-memory (ROM) 730 stores static data and instructions that are needed by the processing unit(s) 710 and other modules of the electronic system 700. The permanent storage device 735, on the other hand, is a read-and-write memory device. This device 735 is a non-volatile memory unit that stores instructions and data even when the electronic system 700 is off. Some embodiments of the invention use a mass-storage device (such as a magnetic or optical disk and its corresponding disk drive) as the permanent storage device 735.

Other embodiments use a removable storage device (such as a floppy disk, flash drive, etc.) as the permanent storage device 735. Like the permanent storage device 735, the system memory 725 is a read-and-write memory device. However, unlike storage device 735, the system memory 725 is a volatile read-and-write memory, such as random-access memory. The system memory 725 stores some of the instructions and data that the processor needs at runtime. In some embodiments, the invention's processes are stored in the system memory 725, the permanent storage device 735, and/or the read-only memory 730. From these various memory units, the processing unit(s) 710 retrieve instructions to execute and data to process in order to execute the processes of some embodiments.

The bus 705 also connects to the input and output devices 740 and 745. The input devices 740 enable the user to communicate information and select commands to the electronic system 700. The input devices 740 include alphanumeric keyboards and pointing devices (also called “cursor control devices”). The output devices 745 display images generated by the electronic system 700. The output devices 745 include printers and display devices, such as cathode ray tubes (CRT) or liquid crystal displays (LCD). Some embodiments include devices such as a touchscreen that function as both input and output devices.

Finally, as shown in FIG. 7, bus 705 also couples electronic system 700 to a network 765 through a network adapter (not shown). In this manner, the computer can be a part of a network of computers (such as a local area network (“LAN”), a wide area network (“WAN”), or an Intranet, or a network of networks, such as the Internet. Any or all components of electronic system 700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs), or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. For instance, a number of the figures conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process.

We claim:

1. A method for modifying settings of a legacy radio access network (RAN), the method comprising:
at a first application executing on a RAN intelligent controller (MC) framework:
from a second application executing on the MC framework, receiving a command to modify at least one setting of the legacy RAN;
translating the command into a set of one or more application programming interface (API) calls to an element management system (EMS) for the legacy RAN; and
sending the API calls to the EMS in order to cause the EMS to modify the at least one setting of the legacy RAN.

2. The method of claim 1, wherein:
the MC framework is a non-real time RIC of a 5G Open RAN (O-RAN); and
the legacy RAN is a 4G LTE RAN.

3. The method of claim 2, wherein the MC framework comprises an interface used by the first and second applications.

4. The method of claim 3, wherein:
the interface comprises a data management and exposure (DME) service;
the second application sends a command to the first application by creating a job on the DME service; and
the DME service identifies the first application as a destination for the job and sends the job to the first application.

5. The method of claim 4 further comprising, upon completion of the job, directly notifying the second application through the interface.

6. The method of claim 1, wherein the command uses a generic data type to specify at least one new value for at least one parameter of at least one legacy RAN cell site.

7. The method of claim 6, wherein the command comprises a set of one or more tuples, each respective tuple specifying (i) a respective legacy RAN cell site, (ii) a respective parameter to be modified for the respective legacy RAN cell site, and (iii) a respective set of one or more new values for the respective parameter.

8. The method of claim 6, wherein translating the command comprises, based on the specified new values for the parameters of the legacy RAN cell sites, generating a work order to send to the EMS, the work order comprising the set of one or more API calls.

9. The method of claim 8, wherein the work order specifies whether the EMS (i) will only change the specified parameters to the specified new values if all of the specified parameters can be successfully changed or (ii) will change any specified parameters to the specified new values that can be changed irrespective of whether some of the specified parameters cannot be successfully changed to the specified new values.

10. The method of claim 1, wherein the command is a first command and the set of API calls is a first set of API calls, the method further comprising:
receiving, from the second application, a second command to retrieve at least one current setting of the legacy RAN;
translating the second command into a second set of one or more API calls to the EMS for the legacy RAN;
sending the second set of API calls to the EMS in order to cause the EMS to provide the at least one current setting of the legacy RAN to the first application; and
providing the at least one setting to the second application.

11. The method of claim 1, wherein the command is a first command, the legacy RAN is a first legacy RAN, the EMS is a first EMS, and the set of API calls is a first set of API calls, the method further comprising:
from the second application, receiving a second command to modify at least one setting of a second legacy RAN;
translating the second command into a second set of one or more API calls to a second EMS for the second legacy RAN; and
sending the second set of API calls to the second EMS in order to cause the second EMS to modify the at least one setting of the second legacy RAN.

12. The method of claim 1, wherein the command is a first command, the at least one setting is a first set of settings, and the set of API calls is a first set of API calls, the method further comprising:
from a third application executing on the RIC framework, receiving a command to modify a second set of settings of the legacy RAN;
translating the second command into a second set of one or more API calls to EMS; and
sending the second set of API calls to the EMS in order to cause the EMS to modify the second set of settings of the legacy RAN.

13. The method of claim 1, wherein the EMS is a particular EMS of a plurality of EMSs for which the first application translates commands, the method further comprising determining that the command will be translated into API calls for the particular EMS.

14. The method of claim 13, wherein:
the received command specifies a particular legacy RAN element; and
determining that the command will be translated into API calls for the particular EMS comprises mapping the particular legacy RAN element to the particular EMS.

15. The method of claim 1, wherein the command specifies, for each respective legacy cell site of a set of legacy cell sites, a respective set of anchor cell sites in a 5G RAN.

16. The method of claim 1, wherein the command specifies a set of legacy cell sites to power off.

17. A non-transitory machine-readable medium storing a first application which when executed by at least one processing unit modifies settings of a legacy radio access network (RAN), the first application executing on a RAN intelligent controller (MC) framework, the first application comprising sets of instructions for:
from a second application executing on the RIC framework, receiving a command to modify at least one setting of the legacy RAN;
translating the command into a set of one or more application programming interface (API) calls to an element management system (EMS) for the legacy RAN; and
sending the API calls to the EMS in order to cause the EMS to modify the at least one setting of the legacy RAN.

18. The non-transitory machine-readable medium 17, wherein:
the MC framework is a non-real time RIC of a 5G Open RAN (O-RAN);
the legacy RAN is a 4G LTE RAN;
the non-RT RIC comprises an interface used by the first and second applications, the interface comprising a data management and exposure (DME) service;
the second application sends a command to the first application by creating a job on the DME service; and
the DME service identifies the first application as a destination for the job and sends the job to the first application.

19. The non-transitory machine-readable medium of claim 18, wherein the first application further comprises a set of instructions for directly notifying the second application through the interface upon completion of the job.

20. The non-transitory machine-readable medium of claim 17, wherein the command comprises a set of one or more tuples, each respective tuple specifying (i) a respective legacy RAN cell site, (ii) a respective parameter to be modified for the respective legacy RAN cell site, and (iii) a respective set of one or more new values for the respective parameter.

21. The non-transitory machine-readable medium of claim 17, wherein:
the command uses a generic data type to specify at least one new value for at least one parameter of at least one legacy RAN cell site; and
the set of instructions for translating the command comprises a set of instructions for generating a work order to send to the EMS based on the specified new values for the parameters of the legacy RAN cell sites, the work order comprising the set of one or more API calls.

22. The non-transitory machine-readable medium of claim 21, wherein the work order specifies whether the EMS (i) will only change the specified parameters to the specified new values if all of the specified parameters can be successfully changed or (ii) will change any specified parameters to the specified new values that can be changed irrespective of whether some of the specified parameters cannot be successfully changed to the specified new values.

23. The non-transitory machine-readable medium of claim 17, wherein the EMS is a particular EMS of a plurality of EMSs for which the first application translates commands, the first application further comprising a set of instructions for determining that the command will be translated into API calls for the particular EMS.

24. The non-transitory machine-readable medium of claim 17, wherein:
the received command specifies a particular legacy RAN element; and
the set of instructions for determining that the command will be translated into API calls for the particular EMS comprises a set of instructions for mapping the particular legacy RAN element to the particular EMS.
